(19) United States
(12) Patent Application Publication
(10) Pub. No.: US 2023/0394080 A1
(43) Pub. Date: Dec. 7, 2023

(54) ELECTRONIC SYSTEM FOR DIGITAL AND PHYSICAL MEDIA

(71) Applicant: Xandrie SA, Pantin (FR)

(72) Inventor: Axel REGAIRAZ, PANTIN (FR)

(73) Assignee: Xandrie SA, Pantin (FR)

(21) Appl. No.: 17/832,254

(22) Filed: Jun. 3, 2022

(51) Int. Cl. G06F 16/635; G06F 16/683; G06F 16/65; H04L 67/306

(52) U.S. Cl. CPC G06F 16/637; G06F 16/685; G06F 16/65; H04L 67/306

(57) ABSTRACT

The disclosure relates to an electronic system and to a method for providing an improved media library to a set of users.

The electronic system comprises an electronic terminal associated with a user. The electronic system submits a physical medium to the electronic terminal based on user profiling. The electronic terminal is configured to request user confirmation that the physical medium submitted should be accounted for in a register of the electronic terminal. It is configured, upon user confirmation, to fetch metadata associated with the submitted physical medium from a register of physical media metadata and store the fetched metadata in a register of the electronic terminal.

BACKGROUND

Multiple kinds of physical media have been used throughout history to store and carry information. These include paintings, books (or other printed documents), phonograph records (“vinyl”), audiocassettes, video tapes, CDs or DVDs. Certain physical media are, at least in part, directly accessible to a human, for example: photo albums, a gardening magazine, or the cover of a vinyl. But many physical media require some electronic device to be fully usable, as is the case for a vinyl, which microgroove must be played on a turntable.

More recently, physical media have often been replaced or supplemented by corresponding digital media. Digital media are data, considered separately from a particular device on which they are stored. Examples of digital media include mp3 music files, PDF documents, e-books or mp4 video files.

Various electronic systems are available for managing and playing digital or physical media. Such systems comprise at least one electronic terminal, for example an mp3 player, a smart phone, e-readers for e-books, a hi-fi, or video projectors. More and more electronic systems of this kind are connected to a network and include a computer server, on which digital media may be stored.

US 2006/0254411 A1 (Alcalde et al.) discloses methods and systems for analyzing and using digital music compositions, and more particularly a method and system for determining the characteristics of a musical composition by analyzing its digital composition, and recommending particular musical compositions to users based upon the relative comparability of a user's desired musical characteristics and the musical characteristics of a collection of digital music.

U.S. Pat. No. 10,380,208 B1 (Brahmbhatt et al.) discloses online services to users based on the current context information of the users. In particular, a user may interact with an interactive device to stream media content or utilize other services provided by a remote service provider. The user may provide commands to the interactive device using a suitable input method. In order for the service providers to provide customized services, the interactive device can be configured to capture additional context sensitive information or contextual data indicative of an environment of the user such as ambient sound, location information, images, and the like, and provide such context sensitive information to the service provider. The service provider can utilize such context-sensitive information to customize the response such that the response is suitable to the current context of the request or command or user or user command.

Personalized Implicit Learning in a Music Recommender System, Suzana Kordumova, Ivana Kostadinovska, Mauro Barbieri, Verus Pronk, Jan Korst, UMAP 2010, LNCS 6075, pp. 351-362, Springer-Verlag Berlin Heidelberg, June 2010, discloses a method to learn how to translate user actions on items to ratings on these items by correlating user actions with explicit feedback. This is done by associating user actions to rated items and subsequently applying naive Bayesian classification to rate new items with which the user has interacted. The method was applied and evaluated on data from a web-based music service.

Missing tracks or albums in Sonos music library, Sonos, 20 Jan. 2022, is a technical support document disclosing that “a music file's metadata specifies organizational labels like the title, artist name, album name, and more. Sonos categorizes music files based on how they're tagged in the metadata. [. . . ] In most cases, a music file that is missing a metadata tag will not appear in the Sonos app where it's supposed to. For example, if a file is missing its “Artist” tag, it won't appear when you browse or search for that particular artist in the Sonos app. You'll need a media library management tool like iTunes to view and edit the metadata on your music files. After making any changes to metadata, make sure you update the music library index”.

### SUMMARY

The disclosure relates to an electronic system and to a method for providing an improved media library to a set of users.

The electronic system comprises a computer server, configured to store user profiles of the users, digital media, and a register of digital media metadata and physical media metadata associated with digital media and physical media.

The computer server is configured to carry out a profiling of the user profiles, to classify them into groups, and the electronic system is configured to submit further media for the user profiles based on the profiling.

The electronic system comprises an electronic terminal associated with a user of the computer server.

The electronic terminal comprises an input device, a monitoring circuit configured to monitor user usage of the electronic system, and local storage configured to store a user profile of the user, including monitoring data from the monitoring circuit, and a register of digital media metadata and physical media metadata associated with digital media and physical media that the user has.

The electronic terminal is configured to request user confirmation, via the input device, that a physical medium that the electronic system submitted should be accounted for in the register of the electronic terminal. It is configured, upon user confirmation, to fetch metadata associated with the submitted physical medium from the register of physical media metadata of the computer server and store the fetched metadata in the register of the electronic terminal.

### BRIEF DESCRIPTION OF THE DRAWINGS

FIG. 1 schematically illustrates a user library and, at a high level, how a user profiling may be carried out in such a library.

FIG. 2 is a diagram showing a profiling method implemented with an ad hoc procedure.

FIG. 3 is a diagram showing a profiling method implemented with an artificial intelligence.

FIG. 4 is a diagram illustrating a smartphone configured to navigate through a music library, and to suggest media to add to the music library.

FIG. 5 is a diagram illustrating a smartphone configured to navigate through a music library, and to accept or reject suggested media to be added to the music library.

FIG. 6 is a diagram illustrating a smartphone configured to navigate through a music library, and to add metadata to the music library.

FIG. 7 is a diagram illustrating steps implemented by a smartphone to suggest media and add them to a media library, optionally with the help of photos taken with the smartphone.

### DETAILED DESCRIPTION

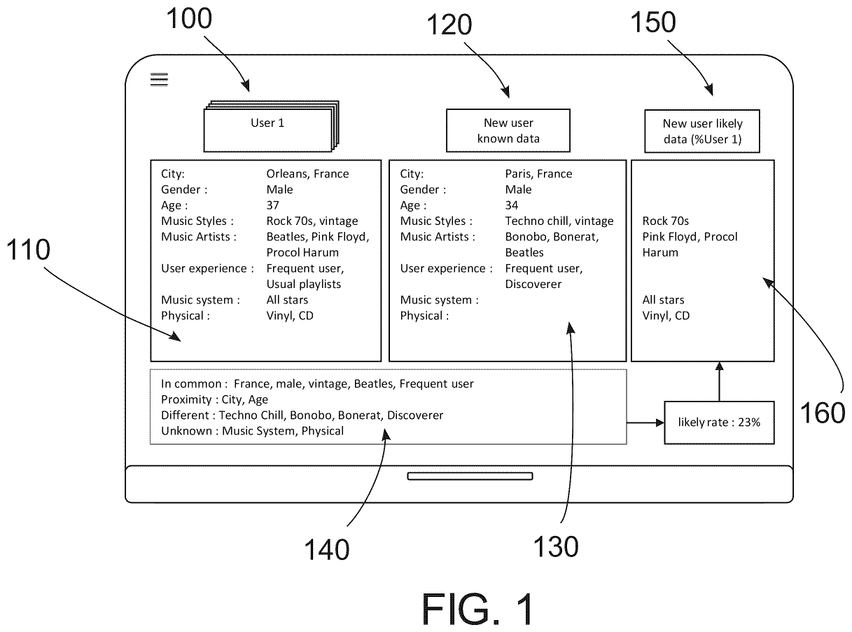

FIG. 1 schematically illustrates a user library symbolized by a stack 100 of users with only the first user (“User 1”) visible, on top of the stack. FIG. 1 shows, at a high level, how a user profiling may be carried out in such a library. Each user has an associated user profile, for example User 1 is associated with profile 110 which includes:
the city where the user resides (Orleans, in France),
the user's gender (Male),
the age of the user (37 years),
some music styles the user enjoys (Rock 70s, vintage),
some music artists the user likes (Beatles, Pink Floyd, Procol Harum),
how often the user uses the music library (frequent user) and the usual playlists of the user,
the Music system of the user (“All stars”), and
the types of physical media in possession of the user (“Vinyl, CD”).

A new user 120 is added to the user library. The new user 120 has a profile 130.

A comparison 140 of profiles 110 and 130 reveals the elements in common between the two profiles (both users are males, they both live in France, they are both frequent users of the user library, they both like the Beatles and vintage music).

The comparison 140 reveals elements which, without being identical, are close (the new user is 34 while User 1 is 37 and they both live in the same region, Orleans being less than 100 miles away from Paris). For these elements, it is possible to compute a proximity score based on a model. For example, it is possible to decide that two users have the same age (100% proximity) if their age difference is less than one year. Age ranges can be defined, e.g. R1 for 0-11 years, R2 for 12-18 years, R3 for 19-25 years, R4 for 26-35 years, R6 for 36-55 years and R7 for 56 years and above. Of course, different values can be used for these ranges. It can then be decided, for example, that users belonging to a same range have a proximity of e.g. 80% age-wise. Other proximity scores can be defined for users belonging to contiguous ranges.

Preferably, all elements of the profile are tagged to determine whether they are subject to an all or nothing comparison (100% the same or 100% different) or, on the opposite, can be the subjected to a fine-grained analysis. The models for such fine-grained analysis are potentially different for each of the elements concerned (age, city of residence, etc.). For example, one approach to assess the proximity with respect to a city of residence can be the distance between the cities.

Some elements between the two profiles are different, which the comparison 140 reveals. Indeed, among music styles enjoyed by the users, some are different, and one listens to music with usual playlists while the other uses a “Discoverer” mode, which randomly selects the songs.

Some elements cannot be compared and are marked as unknown. As can be seen, the music system and the kind of physical media of the new user have not been provided and the comparison 140 cannot take them into account. According to a possible embodiment, when the number of unknown elements in two profiles to be compared (counting only once the unknown elements of the same type in both profiles) is less than a threshold (e.g. 20% of unknown elements max), the proximity of the profiles is assessed without these elements. For example, if 5 out of 30 elements are unknown in a first profile and 3 out of 30 elements are unknown in the second profile, 2 of the unknown elements being of the same type in both profiles, there remains 30−5−3+2=24 elements to be compared (i.e. exactly 80%, and the 20% threshold of unknown elements is met). In this case it could be inaccurate to find a 100% proximity (i.e. complete identity of the profiles) if the 24 elements are identical, since we don't know if the 6 remaining elements (unknown at least in one of the two profiles) are identical or not. It could also be inaccurate to find a 0% proximity if the 24 elements are completely different in the two profiles, while we don't know if the 6 remaining elements are different too. It is possible to accept these potential inaccuracies, or to compute the percentage differently, e.g. add half of the unknown elements as if they were identical, i.e. in the above example the proximity would be between (x+3)/30 where x is the number of identical elements (between 0 and 24).

If certain elements of two profiles are similar without being identical, they can be taken into account based on their proximity score as was discussed above. For example, if 19 of 30 elements are identical, and a 20^{th}, the age, without being identical, has a proximity score of 80%, the overall percentage of proximity (“likely rate” on FIG. 1) can be defined as 19.8/30.

On FIG. 1, the “likely rate” is equal to 23% (i.e. 1.84 on the 8 elements listed).

This “likely rate” can be recomputed for each of the users, i.e. by comparing the new user with each of the already enrolled users. This leads to measuring how close a new user is to each of the preexisting users of the library, i.e. profiling the new user.

Based on this likely rate, the profile of the new user can be enriched (as shown in 150) with data 160 determined from the comparison of “New user” and “User 1” as will be illustrated.

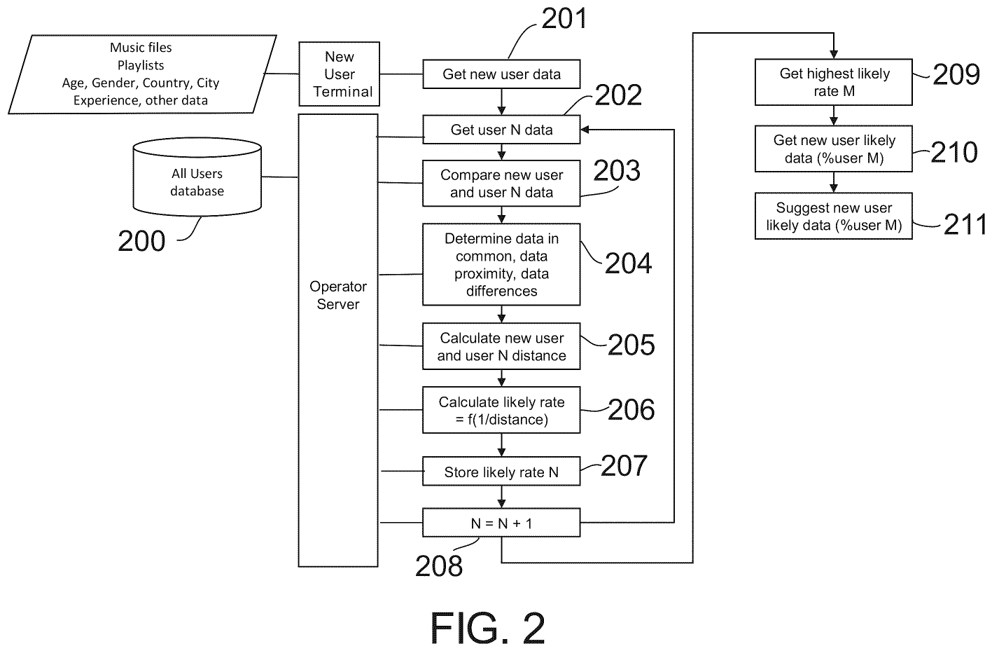

FIG. 2 illustrates more in details the aforementioned profiling method. The method can be implemented by a computer program or by some dedicated electronics.

A database 200 stores information pertaining to all users of a music library. This typically involves storing the user profiles. The database 200 is accessible via a server (an operator's server).

When a new user wishes to be granted access the music library, a first step 201 comprises getting new user data, more specifically looking for information expected in a user profile (age, address, etc.) within the terminal (e.g. smartphone) of the new user.

Then step 202 retrieves corresponding data from the user profile from a first user of the library.

A comparison of the profile of the first user with the data of the new user is then carried out in step 203 in a manner similar to that explained in FIG. 1.

As explained more precisely on FIG. 1, step 204 determines common data, data that is in proximity and data that is different between the first user profile and data representative of the new user profile.

In step 205, as explained more precisely on FIG. 1, common data, data that is in proximity and data that is different in the first user profile and in data representative of the new user profile is used to determine how close the new user is to the first user. This is computed in the form of a distance between the two users. There are many other ways to determine how close the two users are, this one is only one of the possibilities.

In step 206 the likely rate is computed, as a function of the inverse of the distance obtained in step 205. In step 207, the computed likely rate, which is indicative of how close the new user is to the first user, is stored.

Then in step 208 the procedure is repeated for the second, third and in the end all users of the music library. In other words, once the procedure is over, it is possible to assess how close the new user is to any user of the music library.

In step 209, the highest likely rate is identified. This corresponds to the existing user of the music library that is closest to the new user, in view of the criteria selected (in particular the definition of the distance).

In step 210, data of the closest user is retrieved and used to make suggestions to the new user, under the assumption that, being very close, they have similar tastes and interests, and the suggestions are likely to be on point.

In step 211, “user likely data” for the new user are suggested (this may correspond to media that the new user is expected to be interested in in view of similar user's interests).

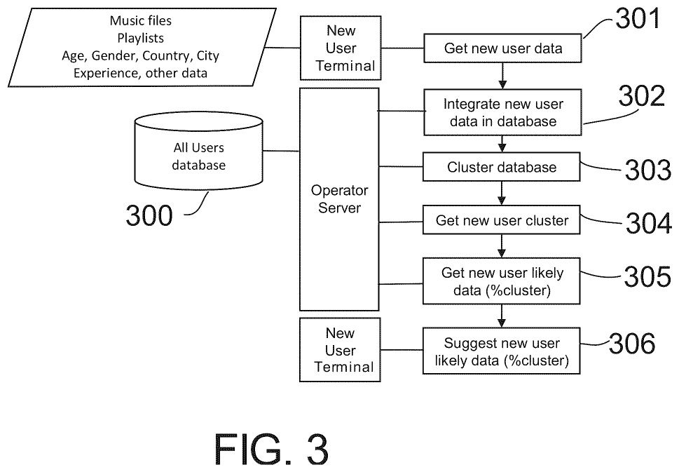

FIG. 3 is a diagram showing a profiling method analogous to that of FIG. 2, except that it is implemented with an artificial intelligence (“AI”). The method can be implemented by a computer program or by some dedicated electronics. The AI based method leads to similar results, but its implementation is completely different.

It is proposed to let an AI sort the users, as opposed to defining an ad hoc algorithm (as in FIG. 2) to do so. An AI can learn by using a supervised method, in which the AI is presented with series of input, and series of expected outputs for these inputs. The AI may implement machine learning based on Bayesian networks, or regression analysis, or decision tree learning, or any appropriate technology. The AI tries to find the outputs and compares its outputs with the expected outputs. Based on how far it was from the expected outputs, the AI adjust itself until it is able to find the outputs correctly. This supervised learning requires a substantial amount of data (the series of inputs and corresponding outputs) for learning, and such data is often not available, as is the case here.

Another way an AI may work is based on an unsupervised learning method. In such a method, the AI draws inputs from a database, without having access to the corresponding outputs. Unsupervised learning is good at sorting sets. Such an AI can be fed with sets of objects, for example user profiles, and find which user profiles can be grouped together due to their proximity. This is called clustering. Accordingly, the profiling technique of FIG. 3 is based on clustering.

A database 300 of users, with their profiles, is made available as in FIG. 2 (it is analogous to database 200). When a new user wishes to be granted access the music library, a first step 301 comprises getting new user data, more specifically looking for information expected in a user profile (age, address, etc.) within the terminal (e.g. smartphone) of the new user. This leads to some user profile for the new user, albeit not necessarily a complete profile.

Then step 302 integrates the new user profile in the database 300.

Step 303 consists in clustering the database with the AI. If the database had already been clustered before, the new clustering may result in adding the new user into an existing cluster. But the whole clustering could also be changed to better group the users together in view of the new user coming in. The clustering depends on how the AI was trained and it is up to the AI to cluster the users based on how it was trained.

Step 304 retrieves the cluster to which the new user has been allocated.

Step 305 then retrieves from this cluster elements used to make suggestions to the new user, under the assumption that, being very close, they have similar tastes and interests, and the suggestions are likely to be on point.

Last, step 306 issues a suggestion in the form of “user likely data” for the new user.

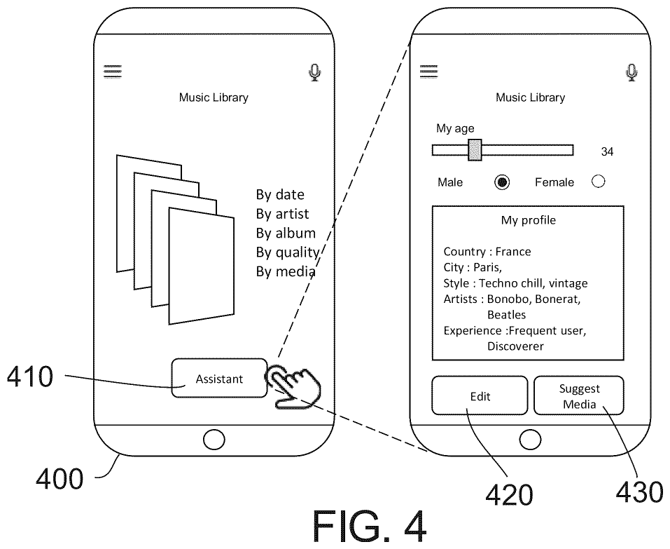

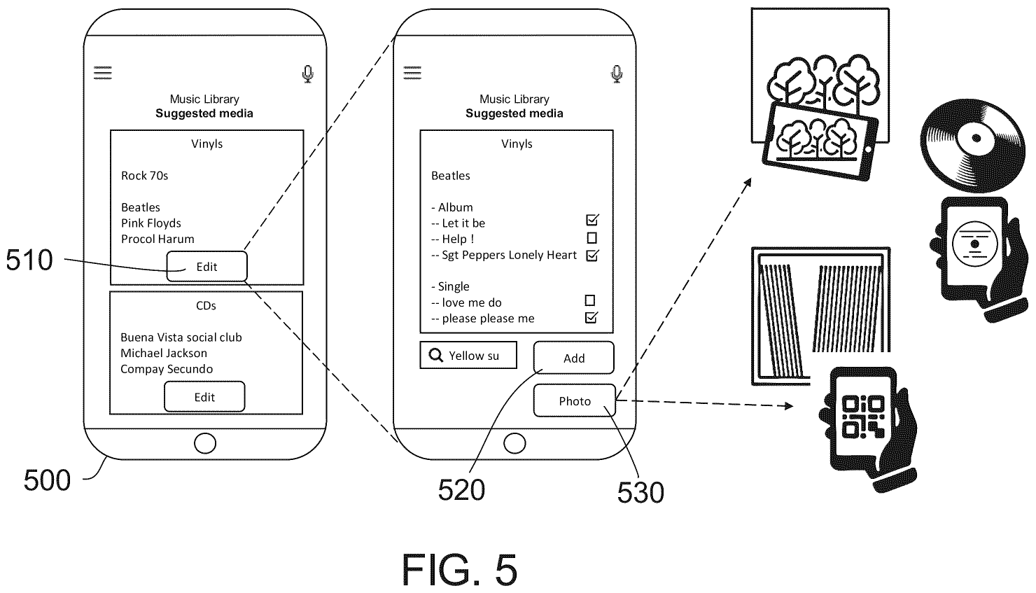

The smartphone 400 of FIG. 4 is configured to navigate through a music library. As can be seen on the screen, the music library can be sorted by date, by artist, by album, by quality or by media. The smartphone comprises a piece of software and hardware (including but not limited to a processor, a memory, a network interface), called “assistant”, arranged to suggest media to add to the music library. When pressing button 410 (labelled “assistant”) on the screen of the smartphone, a new screen appears, displaying the profile of the user of the smartphone. The new screen comprises a button 420 to edit the profile (to add, remove or modify fields). The new screen also comprises a button 430 to make media suggestions (add new media to the music library). When pressing this button, the smartphone triggers all or part of the method of FIG. 2 or of FIG. 3. If the user does not first edit his profile, the previous identification of the closest user is still relevant (if the method according to FIG. 2 was implemented before), and the previous clustering is still relevant (if the method according to FIG. 3 was implemented before). Accordingly, absent an edit in the profile, it is sufficient to implement steps 209 to 211 of FIG. 2 or steps 304 to 306 of FIG. 3 (depending on the method chosen). The procedure continues on to FIG. 5. Other methods could also be used.

As shown on FIG. 5, once a user clicks the “suggest media” button (430) of FIG. 4, the smartphone 500 (which is the same as the smartphone 400 of FIG. 4) shows a list of suggested media obtained according to the method described above. The media are grouped by category, and each category is associated with an “edit” button 510. The category can be the type of medium (Vinyl, CD, local mp3 file, streaming server, etc.). But other kinds of categories can be used and may be specified in a configuration screen.

When clicking the “edit” button 510 for a category, the user is presented with a new screen listing the media (including songs) individually and associating them with selection means (here, a check box per medium but alternatives are possible). This screen has a text box into which the user can type some keywords to narrow the list of media further. The screen comprises an add button 520 to add the selected media to the library. The screen also comprises a photo button 530 to take a photo of a physical medium such as a vinyl (e.g. the cover of the vinyl, or the center of the vinyl, or anything that can provide information assisting in the identification of the physical medium) with the camera embedded in the smartphone.

This function is advantageous because including physical media and in particular vinyls in the library is extremely useful. Not anybody listens to vinyls. Those who do often have very high expectations which influence very significantly the relevance of the suggestions that can be made to them. This input therefore affects the profiling very substantially. In addition, the user is not forced (although it is a possibility) to type some characters to identify the vinyl or other physical device but can also take a picture instead. This is faster, and users who would otherwise not have bothered trying to type in the details necessary for a proper identification of the vinyl could take the picture and improve the relevance of their profile. Taking a picture of a physical medium or of an element of the physical medium (e.g. for a vinyl, a picture of its cover, of its center, or of a barcode printed on it or on its cover) allows identifying the physical medium. To that end, the smartphone may employ a known image recognition tool such as Google AutoML Vision Edge executed from the smartphone. In a possible embodiment, this identification allows the smartphone to complement the list of suggested physical media and to offer the user to select such suggested physical media from the list thanks, for example, to corresponding check boxes.

Preferably, as such selection may lead to the modification of very sensitive elements within the user's profile, the smartphone is arranged to have the completion of the selection trigger a relaunch of the clustering process of FIG. 2 or 3.

An AI based clustering gives very different clusters when the fact that the user has certain vinyls is included, and the same is true of the ad hoc profiling of FIG. 2 when implemented to take this specificity into account.

In FIG. 5, the suggestions are used to add media (whether digital our physical) to the library. However, in preferred embodiments, suggestions can also be used to automatically place a purchase order for a physical medium (e.g. a vinyl that was suggested) and have it delivered to the user. Suggestions can also be used to build automatic playlists, the user being free to skip a song that is in fact not desired. According to a possible embodiment, playlists may include physical media such as vinyls, placed in a jukebox connected to the terminal.

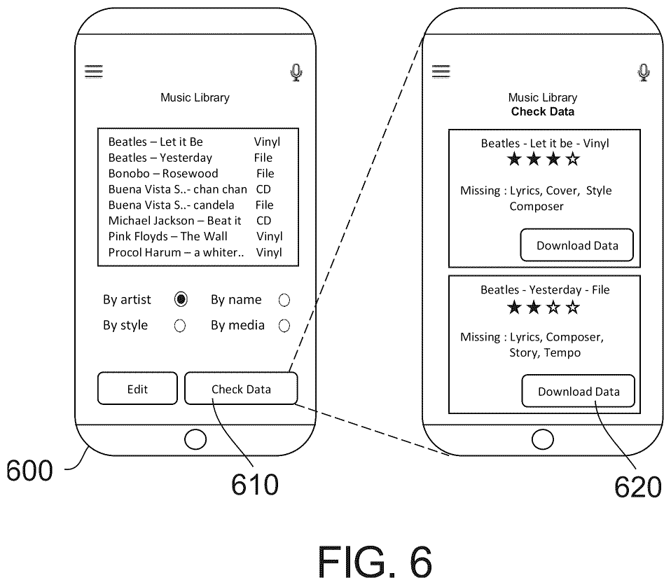

The smartphone 600 of FIG. 6 is configured to navigate through a music library. A “check data” button 610 allows fetching from a database any metadata that would be missing from the library of the user. The library of the user is stored locally in the smartphone so that listening to music is not made dependent on network connectivity, and is much less extensive that the online library, containing the songs that the user is interested in.

While online, the smartphone 600 can therefore press button 610 to check which metadata are missing from his local library. This presents the user with a new screen listing the metadata found and offering to download them by pressing the download button 620.

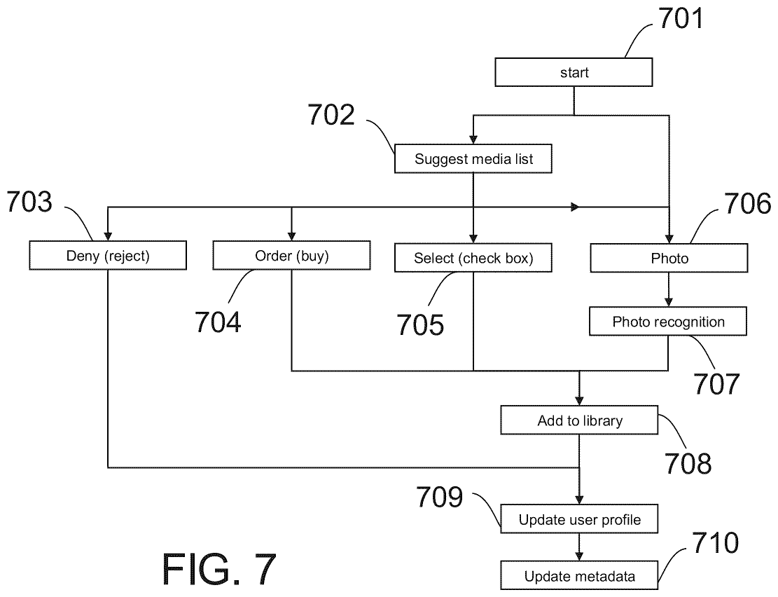

In FIG. 7, a smartphone (or other electronic terminal) is set to suggest a medium (or several media) to a user. The method (which may be embedded in a broader method such as described above) starts from step 701 (“start”). The method can directly suggest a list of media (step 702), for example on the basis of a solution as described above. The smartphone may be configured to then let the user:
deny the suggestion (step 703), for example if it is not relevant to the user;
order (e.g. automatically purchase), in step 704, the suggested media or a subset thereof (which may be chosen by ticking corresponding checkboxes) if the user finds the suggestion relevant and wants to obtain at least some of the suggested media, or
select the suggestion of media or a subset thereof (step 705), this can be achieved, for example, by the smartphone displaying a check box next to each medium of the list of suggested media (check boxes are only an example), and by the user ticking some (or all) of the check boxes, for example if the suggestion corresponds to some medium/media that the user already possesses, thereby notifying the smartphone that the suggestion properly spotted some so-far-non-registered medium or media that was in possession of the user.

Alternatively, the smartphone may be configured to let the user take a photo (step 706), for example a photo of the cover of a vinyl that the user possesses and wants to be taken into account in the user's media library. The smartphone may then carry out an image recognition (step 707), for example with an off-the-shelf tool such as Google AutoML Vision Edge. The smartphone is then configured, based on the output of the image recognition, to identify the physical medium that the user photographed.

In step 708, the smartphone is set to add to the media library the medium or media which has/have been identified, either based on an accepted suggestion (from step 702), or based on a photo by the user (step 706).

Given that adding some media to the media library may have an important effect on the assessment of the user's profile (e.g. expectations and taste), it is advantageous, in a step 709, that the smartphone be configured to trigger an update of the user profile, which may involve re-clustering the user profiles.

In step 710, the smartphone may then trigger an update of the metadata.

According to a possible embodiment, not represented on FIG. 7, step 707 branches just after step 702 instead of going to step 708 immediately. Accordingly, if the photo taken by the user is poor, or if the image recognition and/or smartphone identification of physical medium go wrong, the user may still prevent the erroneously identified physical medium from being added to the library. In a possible embodiment, the image recognition and/or physical media identification processes comprise steps to automatically detect that the process failed to reliably identify a physical medium, in which case no physical medium is added to the media library (the smartphone may notify the user accordingly).

According to a possible embodiment, the smartphone is configured to let the user validate a suggestion made at step 702 by taking a photo (step 706). For example, the suggestion corresponds to a physical medium that the user possesses and instead of clicking on a button to accept the suggestion, the user may take a photo of the physical medium in question, i.e. the smartphone moves from step 702 to step 706.

The above description of embodiments illustrated on FIG. 1 to FIG. 7 is by no means limiting.

In particular, while music libraries are most relevant, the claims are not limited to music libraries, but can comprise book libraries, video libraries or other.

While the use of a smartphone is particularly advantageous, the terminal of the user does not have to be a smartphone: it could be any kind of terminal (laptop, desktop computer, mp3 player, connected watch, HiFi system at home or for a car, etc.).

According to a first embodiment, an electronic system comprises a computer server and an electronic terminal.

The computer server is a piece of hardware with proper server operating system installed on it. The computer server can be formed of several pieces of hardware, e.g. several blades working together, either to improve performance compared to a single blade, or to offer redundancy. The various components are not necessarily collocated. If they are chosen for continuity of service purposes, they are typically distant from one another so that the destruction of one of them (e.g. by fire, flood or theft) doesn't automatically trigger the destruction of the other which are subject to the same or similar danger if in the same place.

The electronic terminal it also a piece of hardware. It can be a smartphone, a laptop, a desktop computer, an e-reader, an mp3 player, a tablet, etc. It is meant to be a user device.

The computer server is designed for providing a media library to a set of users.

The computer server is configured to store user profiles of the users. User profiles are datasets that gather a number of pieces of information about respective users (such as age, place of birth, address, profession, etc.).

The computer server is configured to store digital media, for example music (mp3 music, ogg music, etc.) but the media can be other kinds of media (videos, books, etc.).

The computer server is configured to store a register of digital media metadata and physical media metadata. Digital media metadata are associated with digital media and physical media metadata are associated with physical media. Metadata are data that describes or otherwise complete other data, serving as an informative label (e.g. title of the song, lyrics of the song, date recorded, author, etc.).

The computer server is configured to carry out a profiling of the user profiles, to classify them into groups. In other words, the computer server defines different groups of user profiles such that each group contains user profiles which are all similar to other user profiles of the group, but which are much less similar to user profiles from other groups.

The electronic system (e.g. the computer server, but it could also be done within the electronic terminal) is configured to submit further media for the user profiles based on the profiling. This submission of further media can be viewed as a form of recommendation, made between machines or within a machine, subject to later validation by the human users concerned. Such submission is made possible by the fact that he profiling allows determining the user profiles which best match a given user profile, and the media associated with these best matching user profiles is a source for the submissions as will be seen.

The electronic terminal of the electronic system is associated with a user of the computer server.

The electronic terminal comprises an input device, which can be a touch screen, a keyboard, a mouse, or any other data input interface for a human user. The input device may comprise a camera, such as a smartphone camera, to take pictures of relevant objects and have them recognized and taken into account by the electronic system, as will be seen. The input device may also comprise a microphone with which sounds or music can be captured, analyzed, and used e.g. to identify a particular medium being played.

The electronic terminal comprises a monitoring circuit configured to monitor user usage of the electronic system. For example, the electronic terminal comprises a player allowing the user to play media, and the monitoring circuit records the events corresponding to each medium being played, such as: date and time the given medium was played, location (e.g. based on GPS information or other geolocation information available in the terminal) at which the medium was played, and time/place information for related events such as the user pausing the medium, or the user stopping the medium or rewinding or moving fast forward or skipping to a different medium, wherein the events can also include contextual information (such as the type of application that was running in the terminal at the time of the event, if any, the temperature at the place and time where the event took place, which temperature can be obtained by a sensor of the electronic terminal or downloaded e.g. from a weather forecast server, etc.) or sound recorded in the environment of the user (with a microphone of the electronic terminal). The monitoring circuit can be an ad hoc circuit, based for example on an FPGA or an ASIC. Alternatively, it can be made of a processor and a memory, with an adapted computer program being stored in the memory. The processor and memory may be shared with the electronic terminal (for example, they can be the main processor and main memory of the electronic terminal).

The electronic terminal comprises local storage (hard disk drive, SSD drive, or other type of solid-state storage such as flash disks, SD or micro-SD cards, etc.) configured to store a user profile of the user, such user profile including monitoring data from the monitoring circuit. Indeed, such monitoring data may be useful in assessing user preferences. For example, it can be assumed that a person who listens to hard rock music late at night and keeps switching from song to song before they are finished playing does not have the same kind of profile as one who, instead, listens to classical music early in the morning for longer periods of time, without interruption.

The local storage is also configured to store a register of digital media metadata and physical media metadata associated with digital media and physical media that the user has. That the user “has” certain media can be construed as a form of ownership of the media but also covers the situation of a user who would merely rent or otherwise have access to the media, possibly for a limited duration. Having a medium refers to some form of control over it, e.g. the user can play it, as opposed to a medium for which the user wouldn't have paid or wouldn't otherwise be authorized to play or otherwise use.

It appears from the above that, some user profiles, digital media metadata and physical media metadata are stored both on the computer server and on the local storage of the electronic terminal. The computer server stores user profiles for all users of the system, which is not the case of the electronic terminal, and the same may be true of the metadata, which on the computer server encompass metadata for the media of all users. The user profile and metadata stored in the electronic terminal's local storage are advantageous when the electronic terminal is offline and therefore unable to access the computer server but still able to e.g. browse a media library and play media. According to a preferred embodiment, when a user updates the user profile or digital or physical media metadata directly on the electronic terminal, while offline, the electronic terminal notifies the updates to the computer server at the next opportunity (whenever the electronic terminal goes online again and no policy, such as roaming costs limitations, or privacy settings, prevents the notification). Accordingly, the computer server may update the user profile by a synchronization mechanism, any change (addition, deletion or modification) made on the electronic terminal being propagated to the computer server. The same may be done with the metadata, except that some policy may prevent deletions or modification, only allowing addition, or some policy may flag the changes for verification before applying them, as changes on the computer server may impact other users. Of course, synchronization can work both ways, i.e. changes made on the computer server while the electronic terminal is offline can be propagated to the electronic terminal at the next opportunity. For example, a background ongoing profiling process on the computer server may enrich a user profile on the computer server and the enrichment (i.e. changes) can be pushed to the corresponding electronic terminal user profile. Said differently, if metadata pertaining to physical or digital media are updated on the computer server (e.g. breaking news concerning the artist who authored some media can be added to the corresponding metadata) such changes can be replicated locally in the electronic terminal whenever possible.

The electronic terminal is configured to request user confirmation, via the input device, that a physical medium that the electronic system (e.g. the computer server) submitted should be accounted for in the register of the electronic terminal. Said otherwise, when the electronic system submits that some media can be relevant on a given electronic terminal because of the user profile of the user of the electronic terminal, there must still be user confirmation before corresponding metadata are pushed to the electronic terminal. This is because the user might in fact not have the medium (the computer server suggestions/recommendations are not necessarily on point).

According to the first embodiment, the electronic terminal is therefore configured to request user confirmation, via the input device, that the medium submitted by the electronic system is a physical medium that the user already has.

If the user denies the confirmation request, the electronic system submission processing is over, and the computer server can be notified of the denial by the electronic terminal (and can update the corresponding user profile accordingly).

However, for cases in which the user accepts the electronic system submission by confirming the request, the electronic terminal is configured, upon user confirmation, to fetch metadata associated with the submitted physical medium from the register of physical media metadata of the computer server and to store the fetched metadata in the register of the electronic terminal. Accordingly, the user can now see the medium and its details (metadata) in his media library, with the electronic terminal, even offline.

When finding (based on the profiling) that other similarly situated users typically have a certain medium that the user doesn't seem to have, the computer server may have difficulties assessing the reason. The reason could be that the user doesn't actually have this medium and would benefit from receiving a suggestion tending to have the user acquire this medium. But the reason could also be that the user in fact already has this medium but didn't embed it in the user's media library. This means that this “ownership” (which, as was explained earlier, is not necessarily an ownership in the legal sense but merely a technical possibility of access) of the medium is not known to the electronic system. In some instances, there may be some hints that one reason is more likely than the other. For example, if almost every user with a similar profile has a given medium, it is more likely that the user at stake in fact has this medium too, but simply didn't declare it. However, there is no certainty.

According to a second embodiment, the electronic terminal of the electronic system according to the first embodiment is configured to act upon the user not confirming that the physical medium that the electronic system submitted should be accounted for in the register of the electronic terminal. The user not confirming that the physical medium that the electronic system submitted should be accounted for in the register of the electronic terminal can be the user specifically denying that that the physical medium should be accounted for (e.g. clicking on “NO” in response to a user confirmation request that offers “YES” and “NO” buttons), or can also be the user not reacting to the request during a period exceeding a predefined threshold (e.g. 10 seconds) which can trigger an automatic rejection of the user confirmation request.

The act of the electronic terminal comprises requesting user confirmation, via the input device, that the user wishes to have access to the submitted physical medium. In other words, based on explicit or implicit confirmation that the user doesn't have the submitted physical medium, and based on the fact that the profiling reveals that the submitted physical medium may be of interest to the user, the electronic terminal seeks confirmation from the user that the user is interested in having this submitted physical medium.

The act of the electronic terminal further comprises, upon user confirmation, fetching metadata associated with the submitted physical medium from the register of physical media metadata of the computer server, and storing the fetched metadata in the register of the electronic terminal.

The act of the electronic terminal also comprises granting access to the submitted physical medium. Granting access may take several forms, from automatically ordering the physical medium and having it shipped to a defined address of the user, to merely providing indications on how to procure the submitted physical medium (e.g. address of a store and its opening hours). Intermediate solutions may comprise booking the submitted physical medium and letting the user pick it up.

According to a third embodiment, the electronic terminal of the electronic system according to the first or second embodiment is configured to detect if a medium submitted by the electronic system is a digital medium that the user already has (e.g. an mp3 file or other audio file, a movie file, etc.).

In the positive, the electronic terminal is configured to fetch metadata associated with the submitted digital medium from the register of physical media metadata of the computer server and store the fetched metadata in the register of the electronic terminal. Accordingly, without any user intervention, the electronic terminal may silently download metadata. Of course, in a variant, the electronic terminal may be configured to request user confirmation before doing so.
in the negative (i.e. if it turns out that the user doesn't have the digital metadata), the electronic terminal is configured to request user confirmation, via the input device, that the user wishes to have access the digital medium. Upon user confirmation, it is further configured to:
fetch metadata associated with the submitted digital medium from the register of digital media metadata of the computer server,
store the fetched metadata in the register of the electronic terminal,
grant access to the submitted digital medium. Here, granting access may be done in a fully online manner, without having to deal with a physical delivery or with an actual pickup at a store, for example.

It is therefore advantageous to detect whether the medium submitted by the computer server is a digital medium that the user already has. In case the electronic terminal detects that the user already has the digital medium, everything is consistent in the sense that the media library of the user properly lists the digital medium, and the user actually has it and can for example play it. Such detection is very convenient because it does not involve any interaction with the user, which simplifies the user experience.

There's a major difference between digital and physical media. It is generally impossible to automatically detect that the user has some physical medium. A physical medium (e.g. some vinyl) may have been offered to the user by his grandmother, or the user may have bought the physical medium cash at a garage sale, without any digital hint available to guess that this happened.

User confirmation that a user has a physical medium requires triggering some interaction with the user, and may be in the form of a yes/no question of the type “please confirm that you have [physical medium XYZ]”, or may be more sophisticated. For example, the user can take a photo of the physical medium, e.g. a record, and the electronic terminal may analyze the photo and extract further metadata on top of confirming that the user has the physical medium at stake.

Granting access can take different forms.

When the submitted medium is available as a digital medium, the electronic terminal may for example automatically order (purchase) or rent the digital medium. The electronic terminal may for example place an order for the submitted digital medium, debit some predefined payment means (e.g. recorded bank card, etc.), and automatically download the submitted digital medium into the electronic terminal. This order (purchase) or rent of the digital medium can alternatively be subject to explicit confirmation by the user (via the input device).

If the submitted medium is a physical medium, the electronic terminal may also order (purchase) or, less likely, rent the physical medium, which can be shipped to the user's address.

According to a possible embodiment, the electronic terminal of the electronic system according to the first embodiment comprises a digital medium player circuit arranged to obtain a digital medium from a source comprising at least one of the electronic terminal local storage, the computer server and the Internet.

According to a fourth embodiment, for the electronic system of the third embodiment to detect if the medium submitted by the computer server is a digital medium that the user already has, the electronic terminal is configured to carry out a search for the digital medium within the local storage of the electronic terminal. Indeed, the user not having reported having this digital medium, it is likely to be stored locally (as opposed to being stored on the computer server, where it would be properly referenced). The most likely place to locally store the digital medium is generally the electronic terminal. This is for at least two reasons. First, the user uses this electronic terminal for his media library and it is less convenient to use several terminals or devices for a single purpose when one is sufficient. Second, storing digital media in multiple devices is not always possible, at least without paying extra fees. Indeed, some providers use DRM to protect their digital media. Accordingly, there is often an incentive to centralize digital media in a single place, and the electronic terminal appears to be a very appealing one.

According to a possible embodiment, the electronic terminal is arranged, for example at user profile creation, to ask the user if the user already has another digital media provider. In the affirmative, the electronic terminal is arranged to propose to aggregate the media library of the other provider or providers into the media library of the computer server, and to later synchronize them on a regular basis.

According to a fifth embodiment, the electronic terminal of the electronic system according to any of the first to fourth embodiments is configured, absent a physical medium submission from the computer server, to let the user use the input device to identify a physical medium as a physical medium that the user already has, and to have the electronic terminal account for it in its register. Accordingly, even without the electronic system having been able to identify the relevance of submitting the physical medium in question, the user has a possibility, of his own initiative, to have the electronic system account for it. In a possible embodiment, the electronic terminal is arranged to let the user take a photo of the physical medium (e.g. with camera embedded in the electronic terminal). This can be a photo of the cover of a vinyl, of the vinyl itself, etc. In a possible embodiment (which can be cumulative with the former), the electronic terminal is arranged to have the user type in some key words uniquely identifying the physical medium. In a possible embodiment, if several physical media match the keywords entered by the user or the photo(s) taken, the electronic terminal is arranged to display a list of matching physical media (preferably sorted by decreasing order of likelihood) and let the user chose from the list of physical media.

According to a sixth embodiment, the electronic terminal of the electronic system according to any of the first to fifth embodiments is configured to determine digital and physical media accounted for in the register of the electronic terminal for which metadata are less complete than in the register of the computer server. For example, metadata synchronization between the electronic device and the computer server may be manual (or unavailable), and some media may be associated, at the electronic terminal level, with very limited metadata (e.g. only title and author of the medium being provided).

The electronic terminal is configured to fetch the missing metadata from the register of the computer server, to request fetched metadata validation by the user of the electronic terminal (as the user might be unwilling to update his metadata) and store the fetched metadata in the register of the electronic terminal. Preferably, the metadata are communicated to the user (e.g. displayed or played), for the user to not have to blindly accept or deny metadata updates.

According to a seventh embodiment, the computer server of the electronic system according to any of the first to fifth embodiments is configured to determine digital and physical media accounted for in the register of the electronic terminal for which metadata are less complete than in the register of the computer server. The electronic terminal is configured to fetch the missing metadata from the register of the computer server, request fetched metadata validation by the user of the electronic terminal, and store the fetched metadata in the register of the electronic terminal. The seventh embodiment is very similar to the sixth, except that it is the computer server as opposed to the electronic terminal that determines the media for which metadata might be missing. In both the sixth and the seventh embodiments, neither the electronic terminal nor the computer server can generally carry out this determination alone. Instead, whichever is in charge of this determination should normally contact the other via the network through which they are linked to get the information needed, namely at least the corresponding metadata so that they can be compared and checked for any missing elements on either side, or some hash of the corresponding metadata (to minimize bandwidth usage and only download or upload metadata when needed, i.e. when the hash on the computer server side and on the electronic terminal side are different).

According to an eighth embodiment, to carry out a profiling of the users, the computer server of the electronic system according to any of the first to seventh embodiments is configured to carry out a profiling procedure each time a new user is added to the computer server.

The profiling procedure comprises, for each user of the electronic system, computing a distance between the profile of the user and the profile of the new user, computing a proximity index based on the distance, and storing the proximity index in the profile of the user and in the profile of the new user. The distance is not necessarily a distance in the mathematical sense. But the distance should be representative of how close two profiles are. In a simplified embodiment, the proximity index is equal to the distance (it is up to electronic system to properly assess proximity in view of such proximity index). In more elaborate embodiments, the proximity index is the inverse of the distance. This is advantageous since the more distant two profiles, the less proximity between them. This makes the convention better understandable. In even more elaborate embodiments, the proximity index is not directly the inverse of the distance but a function of this inverse. Indeed, the relevant proximity is not necessarily the inverse of the distance. Depending on how the distance is defined, a multiplicative factor may be applied to the inverse of the distance to make it more relevant, or a non-linear function may even be applied.

According to a ninth embodiment, to carry out a profiling of the users, the computer server of the electronic system according to any of the first to seventh embodiments comprises an unsupervised artificial intelligence circuit, trained to carry out a clustering of the user profiles stored in the computer server. By unsupervised artificial intelligent circuit, what is meant is not that the electronic system has no control whatsoever over this circuit. Rather, it means that the artificial intelligence circuit is subject to unsupervised learning, according to which, during its learning phase, it is fed with input data without being told what output data are expected. This is by contrast with supervised learning. The unsupervised artificial intelligent circuit can be an ad hoc circuit, based for example on an FPGA or an ASIC. Alternatively, it can be made of a processor and a memory, with an adapted computer program being stored in the memory. The processor and memory may be shared with the computer server (for example, they can be a main processor and a main memory of the computer server, or at least one of the processors and memories of the computer server).

The computer server is configured to carry out a profiling procedure each time a new user is added to the computer server. The profiling procedure comprises clustering the user profiles stored in the computer server with the unsupervised artificial intelligence circuit.

According to a possible embodiment, the artificial intelligence circuit is also trained to make a selection of media to be submitted for a given user profile. Accordingly, once the artificial intelligence circuit has been trained, its parameters (e.g. weights of neural network nodes for an artificial intelligence circuit based on a neural network) can be transferred from the computer server to the electronic terminal, allowing the electronic terminal to submit media while offline (while disconnected from the computer server). The artificial intelligence circuit can be deemed to be trained when it has converged (e.g. for a neural network, when the weights of the neural network nodes have stabilized). Alternatively, the selection of media is carried out with an ad hoc method, on the basis of the clustering.

The training of the artificial intelligence circuit is preferably continuous, meaning that even once it has converged, it continues to be updated regularly to account for changes such as new media becoming available (new music composers, etc.) and changes in the profiles of the users (which may affect the selection of the media to be submitted). Accordingly, the parameters of the artificial circuit, assuming they have been downloaded to the electronic terminal, can be updated from time to time on the electronic terminal.

According to a tenth embodiment, the terminal of the electronic system according to any of the first to ninth embodiments is a smartphone and the input device is a camera of the smartphone.

In an eleventh embodiment, the input device of the electronic system according to any of the first to ninth embodiments is a 3D camera and the media library is stored in a metaverse. The terminal is, for example, a smartphone comprising a 3D camera used as the input device. A media library may include user profiles of the users, digital media, and a register of digital media metadata and physical media metadata associated with digital media and physical media and in the eleventh embodiment, the media library includes at least 3D images of physical media. The media library preferably also includes a digital form of the physical media. The 3D camera may be used to take 3D pictures of physical media and include them in the metaverse. The electronic system is preferably configured to automatically store such 3D pictures into the metaverse. In a possible embodiment, the computer server hosts the media library on behalf of the metaverse. In an alternative, the media library is duplicated, i.e. it is present both in the metaverse and in the computer server, in addition to possibly being copied on the terminal (in full or in part, e.g. for cache purposes).

According to a twelfth embodiment, a method is proposed to provide a media library in an electronic system comprising a computer server and an electronic terminal associated with a user of the computer server.

The method comprises the computer server storing user profiles of the users, digital media, and a register of digital media metadata and physical media metadata associated with digital media and physical media.

The method comprises the computer server carrying out a profiling of the user profiles, to classify them into groups.

The method comprises the electronic system submitting further media for the user profiles based on the profiling.

In the method, the electronic terminal comprises an input device, a monitoring circuit configured to monitor user usage of the electronic system, and local storage storing a user profile of the user, the user profile including monitoring data from the monitoring circuit, and a register of digital media metadata and physical media metadata associated with digital media and physical media that the user has.

The method comprises the electronic terminal requesting user confirmation, via the input device, that a physical medium that the electronic system submitted should be accounted for in the register of the electronic terminal.

Upon user confirmation, the method comprises the electronic terminal:
fetching metadata associated with the submitted physical medium from the register of physical media metadata of the computer server, and
storing the fetched metadata in the register of the electronic terminal.

The method according to the twelfth embodiment is a method implemented in an electronic system according to the first embodiment. Explanations made with respect to the first embodiment can be transposed to the twelfth embodiment. Similarly, the second to eleventh embodiments can be transposed to the twelfth embodiment without a need to explicitly restate the corresponding thirteenth to twenty second embodiments.

The object of the claims is not limited to any specific media. Examples of physical media may include photos, books or newspapers. Physical media may have digital twins in a metaverse. The photos can be 3D photos. They may be extracted from an image by object recognition in an image. The media library can be a database of objects present in a metaverse.

What is claimed is:

1. An electronic system comprising a computer server for providing a media library to a set of users, the computer server being configured to:
store:
user profiles of the users,
digital media, and
a register of digital media metadata and physical media metadata associated with digital media and physical media,
carry out a profiling of the user profiles, to classify them into groups,
the electronic system being configured to submit further media for the user profiles based on the profiling,
the electronic system comprising an electronic terminal associated with a user of the computer server, the electronic terminal
comprising an input device, a monitoring circuit configured to monitor user usage of the electronic system, and local storage configured to store:
a user profile of the user, including monitoring data from the monitoring circuit, and
a register of digital media metadata and physical media metadata associated with digital media and physical media that the user has,
configured to:
request user confirmation, via the input device, that a physical medium that the electronic system submitted should be accounted for in the register of the electronic terminal,
upon user confirmation, fetch metadata associated with the submitted physical medium from the register of physical media metadata of the computer server,
store the fetched metadata in the register of the electronic terminal.

2. The electronic system according to claim 1, the electronic terminal being configured, upon the user not confirming that the physical medium that the electronic system submitted should be accounted for in the register of the electronic terminal, to request user confirmation, via the input device, that the user wishes to have access to the submitted physical medium, and upon user confirmation:
fetch metadata associated with the submitted physical medium from the register of physical media metadata of the computer server,
store the fetched metadata in the register of the electronic terminal, grant access to the submitted physical medium.

3. The electronic system according to claim 1, the electronic terminal being configured to detect if a medium submitted by the electronic system is a digital medium that the user already has, and
in the positive:
fetch metadata associated with the submitted digital medium from the register of physical media metadata of the computer server,
store the fetched metadata in the register of the electronic terminal;
in the negative:
request user confirmation, via the input device, that the user wishes to have access the digital medium, and upon user confirmation:
fetch metadata associated with the submitted digital medium from the register of digital media metadata of the computer server,
store the fetched metadata in the register of the electronic terminal, grant access to the submitted digital medium.

4. The electronic system according to claim 3, wherein, to detect if the medium submitted by the computer server is a digital medium that the user already has, the electronic terminal is configured to carry out a search for the digital medium within the local storage of the electronic terminal.

5. The electronic system according to claim 1, wherein the electronic terminal is configured, absent a physical medium submission from the computer server, to let the user use the input device to identify a physical medium as a physical medium that the user already has, and to have the electronic terminal account for it in its register.

6. The electronic system according to claim 1, wherein the electronic terminal is configured to determine digital and physical media accounted for in the register of the electronic terminal for which metadata are less complete than in the register of the computer server, the electronic terminal being configured to:
fetch the missing metadata from the register of the computer server,
request fetched metadata validation by the user of the electronic terminal, and
store the fetched metadata in the register of the electronic terminal.

7. The electronic system according to claim 1, wherein the computer server is configured to determine digital and physical media accounted for in the register of the electronic terminal for which metadata are less complete than in the register of the computer server, the electronic terminal being configured to:
fetch the missing metadata from the register of the computer server,
request fetched metadata validation by the user of the electronic terminal, and
store the fetched metadata in the register of the electronic terminal.

8. The electronic system according to claim 1, wherein, to carry out a profiling of the users, the computer server is configured to:
carry out a profiling procedure each time a new user is added to the computer server, wherein the profiling procedure comprises, for each user of the electronic system:
computing a distance between the profile of the user and the profile of the new user,
computing a proximity index based on the distance, and
storing the proximity index in the profile of the user and in the profile of the new user.

9. The electronic system according to claim 1, wherein, to carry out a profiling of the users, the computer server:
comprises an unsupervised artificial intelligence circuit, trained to carry out a clustering of the user profiles stored in the computer server, and
is configured to carry out a profiling procedure each time a new user is added to the computer server, wherein the profiling procedure comprises clustering the user profiles stored in the computer server with the unsupervised artificial intelligence circuit.

10. The electronic system according to claim 1, wherein the terminal is a smartphone and the input device is a camera of the smartphone.

11. The electronic system according to claim 1, wherein the input device is a 3D camera and the media library is stored in a metaverse.

12. A method to provide a media library in an electronic system comprising a computer server and an electronic terminal associated with a user of the computer server,
the method comprising the computer server:
storing:
user profiles of the users,
digital media, and
a register of digital media metadata and physical media metadata associated with digital media and physical media,
carrying out a profiling of the user profiles, to classify them into groups,
the electronic system submitting further media for the user profiles based on the profiling,
the method comprising the electronic terminal:
comprising an input device, a monitoring circuit configured to monitor user usage of the electronic system, and local storage storing:
a user profile of the user, including monitoring data from the monitoring circuit, and
a register of digital media metadata and physical media metadata associated with digital media and physical media that the user has,
requesting user confirmation, via the input device, that a physical medium that the electronic system submitted should be accounted for in the register of the electronic terminal,
upon user confirmation, fetching metadata associated with the submitted physical medium from the register of physical media metadata of the computer server, and
storing the fetched metadata in the register of the electronic terminal.

13. The method according to claim 12, the electronic terminal, upon the user not confirming that the physical medium that the electronic system submitted should be accounted for in the register of the electronic terminal:
requesting user confirmation, via the input device, that the user wishes to have access to the submitted physical medium, and upon user confirmation:
fetching metadata associated with the submitted physical medium from the register of physical media metadata of the computer server,
storing the fetched metadata in the register of the electronic terminal,
granting access to the submitted physical medium.

14. The method according to claim 12, the electronic terminal detecting if a medium submitted by the electronic system is a digital medium that the user already has, and in the positive:
fetching metadata associated with the submitted digital medium from the register of physical media metadata of the computer server,
storing the fetched metadata in the register of the electronic terminal;
in the negative:
requesting user confirmation, via the input device, that the user wishes to have access the digital medium, and upon user confirmation:
fetching metadata associated with the submitted digital medium from the register of digital media metadata of the computer server,
storing the fetched metadata in the register of the electronic terminal,
granting access to the submitted digital medium.

15. The method according to claim 14, wherein, to detect if the medium submitted by the computer server is a digital medium that the user already has, the method comprises the electronic terminal carrying out a search for the digital medium within the local storage of the electronic terminal.

16. The method according to claim 12, comprising, absent a physical medium submission from the computer server, the electronic terminal letting the user use the input device to identify a physical medium as a physical medium that the user already has, and to have the electronic terminal account for it in its register.

17. The method according to claim 12, comprising the electronic terminal determining digital and physical media accounted for in the register of the electronic terminal for which metadata are less complete than in the register of the computer server, and the electronic terminal:
fetching the missing metadata from the register of the computer server,
requesting fetched metadata validation by the user of the electronic terminal, and
storing the fetched metadata in the register of the electronic terminal.

18. The method according to claim 12, comprising the computer server determining digital and physical media accounted for in the register of the electronic terminal for which metadata are less complete than in the register of the computer server, and
the electronic terminal:
fetching the missing metadata from the register of the computer server,
requesting fetched metadata validation by the user of the electronic terminal, and
storing the fetched metadata in the register of the electronic terminal.

19. The method according to claim 12, wherein, to carry out a profiling of the users, the method comprises the computer server:
carrying out a profiling procedure each time a new user is added to the computer server, wherein the profiling procedure comprises, for each user of the electronic system:
computing a distance between the profile of the user and the profile of the new user,
computing a proximity index based on the distance, and
storing the proximity index in the profile of the user and in the profile of the new user.

20. The method according to claim 12, wherein, to carry out a profiling of the users, the method comprises the computer server:
comprising an unsupervised artificial intelligence circuit, trained to carry out a clustering of the user profiles stored in the computer server, and
carrying out a profiling procedure each time a new user is added to the computer server, wherein the profiling procedure comprises clustering the user profiles stored in the computer server with the unsupervised artificial intelligence circuit.
